(19) United States
(12) Patent Application Publication
(10) Pub. No.: US 2018/0356499 A1
(43) Pub. Date: Dec. 13, 2018

(54) LASER RANGING DEVICE, IMAGE-CAPTURING APPARATUS, AND TERMINAL

(71) Applicant: GIONEE COMMUNICATION EQUIPMENT CO.,LTD. SHENZHEN, Shenzhen (CN)

(72) Inventor: Xiaofeng HUANG, Shenzhen (CN)

(73) Assignee: GIONEE COMMUNICATION EQUIPMENT CO.,LTD. SHENZHEN, Shenzhen (CN)

(21) Appl. No.: 15/539,891

(22) PCT Filed: May 18, 2016
(86) PCT No.: PCT/CN2016/082554

§ 371 Date: Jun. 26, 2017

(30) Foreign Application Priority Data
Dec. 18, 2015 (CN) 201521071449.3

(51) Int. Cl. G01S 7/481; G01S 17/08; G03B 13/20

(52) U.S. Cl. CPC G01S 7/4811; G03B 13/20; G01S 17/08

(57) ABSTRACT

A laser ranging device, an image-capturing apparatus, and a terminal is disclosed. The laser ranging device includes a laser ranging sensor and a cover plate. A light emitter and a light receiver are provided separately in the laser ranging sensor. The cover plate is provided above the laser ranging sensor. The cover plate includes a first light-transmitting portion, a second light-transmitting portion, and a light-blocking layer. The first light-transmitting portion and the second light-transmitting portion are provided correspondingly to the light emitter and the light receiver, respectively. The light emitter emits a light beam to a detected object through the first light-transmitting portion. The light beam is reflected to the light receiver through the second light-transmitting portion by the detected object and is received by the light receiver. The light-blocking layer is provided between the first light-transmitting portion and the second light-transmitting portion.

### CROSS REFERENCE TO RELATED APPLICATIONS

The present application claims priority to Chinese Utility Model No. 201521071449.3, filed on Dec. 18, 2015 and entitled “LASER RANGING DEVICE, IMAGE-CAPTURING APPARATUS, AND TERMINAL”, the content of which is hereby incorporated by reference in its entirety.

### TECHNICAL FIELD

The present disclosure relates to optics, and more particularly, to a laser ranging device, an image-capturing apparatus, and a terminal.

### BACKGROUND

Near-infrared laser ranging technology can quickly measure a distance from a detected object to a sensor, based on TOF (time of fly) of a photon. A laser ranging sensor can measure a target distance based on the TOF from emission of the photon to the receipt of the photon by emitting and receiving near-infrared light. When the ranging technology is applied to a terminal having a photographing function, such as a mobile phone, an auto focusing speed is increased with the distance information, so as to have better photographing experience.

Currently, since generally the laser ranging sensor should emit and receive the near-infrared light, an optical window should generally be provided in the housing of the terminal, and a light-transmitting cover plate is generally provided on the surface of the optical window so as to seal the optical window. Meanwhile, the light-transmitting cover plate enables a light emitter of the laser ranging sensor to emit light to the detected object. The light is reflected to a light receiver through the optical window by the detected object and is received by the light receiver, so as to achieve a purpose that the target distance is measured. However, when the light emitted from the light emitter is directly reflected to the light receiver by the light-transmitting cover plate, the light readily causes crosstalk for the infrared light, thereby rendering the result of measuring the target distance less accurate, thus failing to increase the auto focusing speed.

### SUMMARY

A laser ranging device according to the present disclosure can prevent the light emitted by the light emitter from being reflected to the light receiver to cause crosstalk for the infrared light, and ensure the accuracy of the result of measuring the target distance.

In addition, the present disclosure provides an image-capturing apparatus comprising the laser ranging device.

Accordingly, the present disclosurefurther provides a terminal comprising the image-capturing apparatus.

In order to solve the technical problem, the present disclosure provides a laser ranging device including a laser ranging sensor and a cover plate. A light emitter and a light receiver are provided separately in the laser ranging sensor. The cover plate is provided above the laser ranging sensor. The cover plate includes a first light-transmitting portion, a second light-transmitting portion, and a light-blocking layer. The first light-transmitting portion and the second light-transmitting portion are provided correspondingly to the light emitter and the light receiver, respectively. The light emitter emits a light beam to a detected object through the first light-transmitting portion. The light beam is reflected to the light receiver through the second light-transmitting portion by the detected object and is received by the light receiver. The light-blocking layer is provided between the first light-transmitting portion and the second light-transmitting portion.

In addition, the present disclosure further provides an image-capturing apparatus including a camera assembly, a processor, and the laser ranging device. The processor is electrically connected to the camera assembly. The laser ranging device is electrically connected to the processor. The laser ranging device sends a measurement result to the processor. The processor feeds the measurement result back to the camera assembly such that the camera assembly receives the measurement result and performs focusing for capturing images.

In addition, the present disclosure further provides a terminal including a housing and the image-capturing apparatus which is provided in the housing.

According to the laser ranging device, the image-capturing apparatus, and the terminal of the present disclosure, the first light-transmitting portion and the second light-transmitting portion are provided in the positions in the cover plate corresponding to the light receiver and the light emitter of the laser ranging sensor, respectively, so as to facilitate light transmission and light receipt, and the light-blocking layer capable of blocking the light beam emitted by the light emitter to a position rather than the first light-transmitting portion is provided between the first light-transmitting portion and the second light-transmitting portion, thereby preventing the light beam from being reflected to the light receiver to cause crosstalk for emission and receipt of the infrared light, and ensuring the accuracy of the result of the laser ranging sensor measuring the target distance.

### BRIEF DESCRIPTION OF DRAWINGS

In order to more clearly describe technical solutions of the present disclosure, accompanying drawings used in the implementations will be briefly introduced hereinafter. Apparently, the accompanying drawings described hereinafter show some implementations of the present disclosure, and persons skilled in the art may also derive other drawings from these accompanying drawings without creative efforts.

FIG. 1 is a schematic structural view of a laser ranging device according to a first implementation of the present disclosure.

FIG. 2 is a perspective view of a cover plate according to the first implementation of the present disclosure.

FIG. 3 is another schematic structural view of the cover plate according to the first implementation of the present disclosure.

FIG. 4 is a schematic structural view of a laser ranging device according to a second implementation of the present disclosure.

FIG. 5 is a schematic structural view of a laser ranging device according to a third implementation of the present disclosure.

FIG. 6 is a schematic structural view of a cover plate according to the third implementation of the present disclosure.

FIG. 7 is another schematic structural view of the cover plate according to the third implementation of the present disclosure.

FIG. 8 is a schematic structural view of a laser ranging device according to a fourth implementation of the present disclosure.

### DETAILED DESCRIPTION

A clear, complete description for the technical solutions of implementations of the present disclosure is provided below, in conjunction with the drawings in the implementations of the present disclosure. Apparently, the implementations to be described are a part of rather than all implementations of the present disclosure. All other implementations obtained by persons skilled in the art from the implementations given herein without creative efforts should fall within the protection scope of the present disclosure.

For convenience of description, spatially relative terms, such as “under”, “below”, “down”. “above”, “up”, and so on, may be used herein to describe relationship between an element or feature and another(other) element(s) or feature(s) as illustrated in the drawings. It should be understood that, when an element or layer is “on” or “connected to” or “coupled to” another element or layer as stated, it may be on or connected to or coupled to another element or layer, directly or via an intermediate element or layer.

It should be understood that the terms used herein are for describing particular implementations only and are not intended to be limiting of the present disclosure. As used herein, the singular forms “a”, “an” and “the” are intended to include the plural forms as well, unless the context clearly indicates otherwise. Furthermore, the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof. What is described hereinafter is typical implementations of the present disclosure, however, this description is for the purpose of describing general principles of the present disclosure, and is not intended to limit the scope of the present disclosure. The protection scope of the present disclosure should be subject to the protection scope defined in the appended claims.

An implementation of the present disclosure provides a terminal including a housing (not illustrated) and an image-capturing apparatus provided in the housing. The image-capturing apparatus includes a camera assembly (not illustrated), a processor (not illustrated), and a laser ranging device 100, The processor is electrically connected to the camera assembly. The laser ranging device 100 is electrically connected to the processor. The laser ranging device 100 sends a measurement result to the processor. The processor feeds the measurement result back to the camera assembly, such that the camera assembly receives the measurement result and performs focusing for capturing images.

In the implementation of the present disclosure, the image-capturing apparatus may be a camera or a monitor or the like. The terminal may be, but is not limited to, a mobile phone, a laptop PC, a tablet PC, and the like. In this implementation, the terminal is described by taking the mobile phone for example.

The image-capturing apparatus is provided with a casing (not illustrated). The laser ranging device 100 is provided in the casing of the image-capturing apparatus and the casing is provided with a light-transmitting window (not illustrated). The laser ranging device 100 emits a light beam to the detected object through the light-transmitting window, and the light beam can be reflected by the detected object, thereby obtaining the measurement result. The processor processes the measurement result and feeds the measurement result back to the camera assembly, thereby achieving a purpose that the focusing speed of the camera is increased when the camera is capturing images, and in turn having a better image-capturing experience.

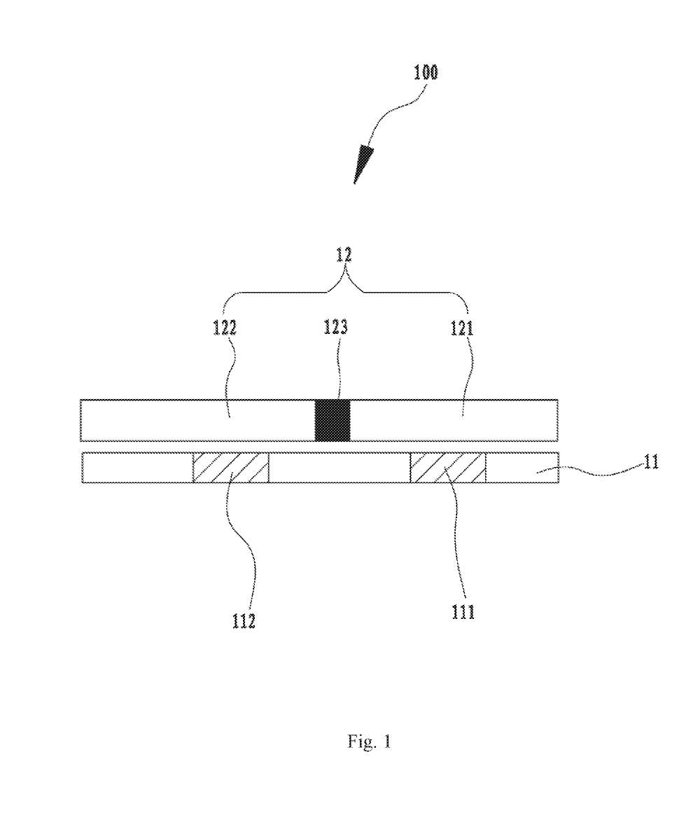

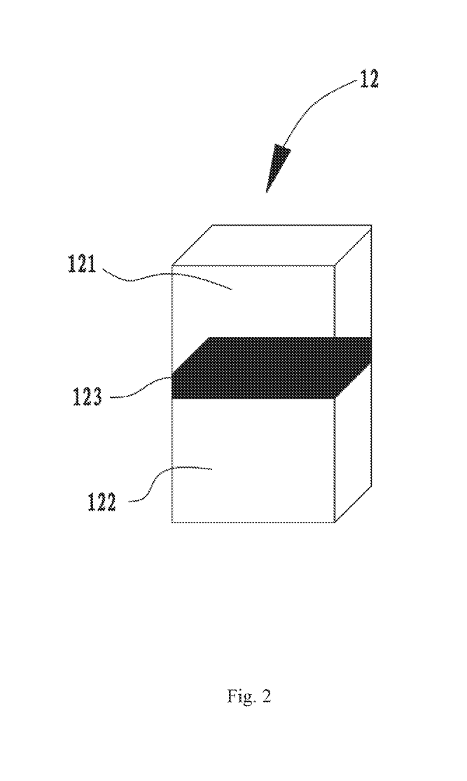

Typically, FIGS. 1 to 3 illustrate the laser ranging device 100 according to a first implementation of the present disclosure. The laser ranging device 100 includes a laser ranging sensor 11 and a cover plate 12. A light emitter 111 and a light receiver 112 are provided separately in the laser ranging sensor 11. The cover plate 12 is provided above the laser ranging sensor 11, and the cover plate 12 includes a first light-transmitting portion 121, a second light-transmitting portion 122, and a light-blocking layer 123. The first light-transmitting portion 121 and the second light-transmitting portion 122 are provided correspondingly to the light emitter 111 and the light receiver 112, respectively. The light emitter 111 emits a light beam to the detected object through the first light-transmitting portion 121, and the light beam is reflected to the light receiver 112 through the second light-transmitting portion 122 by the detected object and is received by the light receiver 112. The light-blocking layer 123 is provided between the first light-transmitting portion 121 and the second light-transmitting portion 122, and the light-blocking layer 123 serves to block the light beam emitted by the light emitter 111 to the outside of the first light-transmitting portion 121.

Typically, when the laser ranging device 100 is provided on the inside of the light-transmitting window, the light emitter 111 emits the light beam through the first light-transmitting portion 121 of the cover plate 12, and the light beam exits through the light-transmitting window and reaches the detected object. Then the light beam is reflected to the light receiver 112 through the light-transmitting window and the second light-transmitting portion 122 by the detected object, and is received by the light receiver 112. The time when the light beam is emitted, reaches the detected object, goes back, and is received by the light receiver 112 is recorded and processed, thereby achieving a purpose that the target distance is measured.

In this implementation, the cover plate 12 is formed of transparent material, and the light-blocking layer 123 is embedded in the cover plate 12. The cover plate 12 may be formed of optical grade transparent material, such as optical glass. The cover plate 12 may be shaped according to the shape of the light-transmitting window. For example, when the light-transmitting window is a circular hole or a square hole, the cover plate 12 is a corresponding circular plate-like structure or square plate-like structure.

In order to ensure the blocking effect of the light-blocking layer 123, the light-blocking layer 123 is sandwiched between the first light-transmitting portion 121 and the second light-transmitting portion 122. Typically, the first light-transmitting portion 121 and the second light-transmitting portion 122 may be stuck to the light-blocking layer 123 by means of adhesive, respectively. For example, the first light-transmitting portion 121 is firstly well placed, and then the light-blocking layer 123 is stuck to the first light-transmitting portion 121, and further the second light-transmitting portion 122 is stuck to the light-blocking layer 123. In addition, when the cover plate 12 is machined, the cover plate 12 may be injection-molded by firstly molding the first light-transmitting portion 121, then placing the light-blocking layer 123 in a cavity of a mold, and then performing injection such that the formed light-blocking layer 123 is sandwiched between the first light-transmitting portion 121 and the second light-transmitting portion 122.

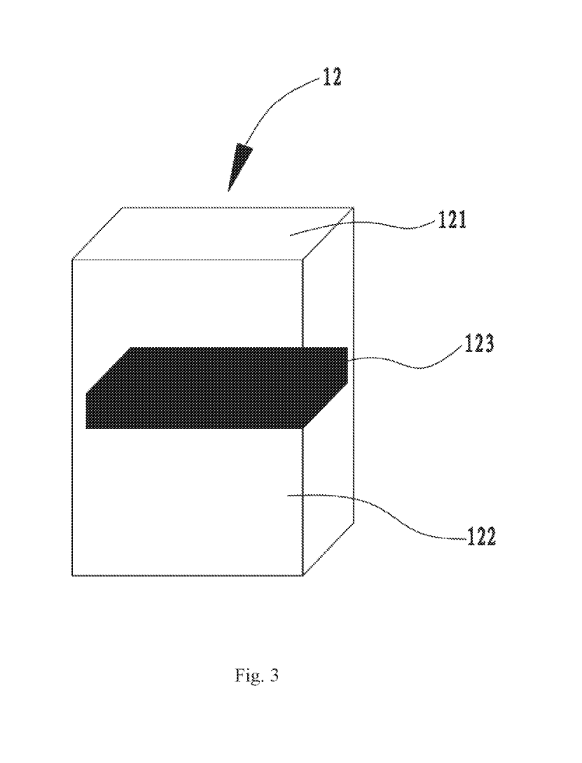

Furthermore, FIG. 3 is a schematic view of another structure formed by the light-blocking layer 123 and the cover plate 12. As illustrated in FIG. 3, an accommodating groove (not illustrated) is formed in the cover plate 12, and the light-blocking layer 123 is fixed in the accommodating groove. Since the accommodating groove is formed in the cover plate 12, a distance is formed between the accommodating groove 12 and the edge of the cover plate 12, that is to say, a distance is formed between the light-blocking layer 123 and the cover plate 12. Thus, the overall structural strength of the cover plate 12 formed in this way is fine.

Typically, the light-blocking layer 123 may be a metal layer, and the light-blocking layer 123 may be an aluminum sheet, an iron sheet, a steel sheet, or the like. Since the metal has a good light-blocking property, the good light-blocking effect may be ensured when the light-blocking layer 123 is a metal layer. Moreover, in order to further ensure the blocking effect, when the light-blocking layer 123 is an aluminum sheet, the aluminum sheet may be oxidized and then embedded into the cover plate 12. Naturally, it should be understood that, in other implementations, the light-blocking layer 123 may also be a graphite sheet or other light-blocking material.

In the laser ranging device 100 according to the first implementation of the present disclosure, the light-blocking layer 123 is provided on the cover plate 12, and the light-blocking layer 123 is embedded in the cover plate 12, thereby blocking the light beam emitted by the light emitter 111 to the outside of the first light-transmitting portion 121, and in turn preventing the light beam from being reflected to and received by the light receiver 112 to cause interference for the distance measurement of the laser ranging device 100. Furthermore, since the light-blocking layer 123 is a metal layer which has a fine light-blocking property, the light-blocking effect of the light-blocking layer 123 can be further ensured.

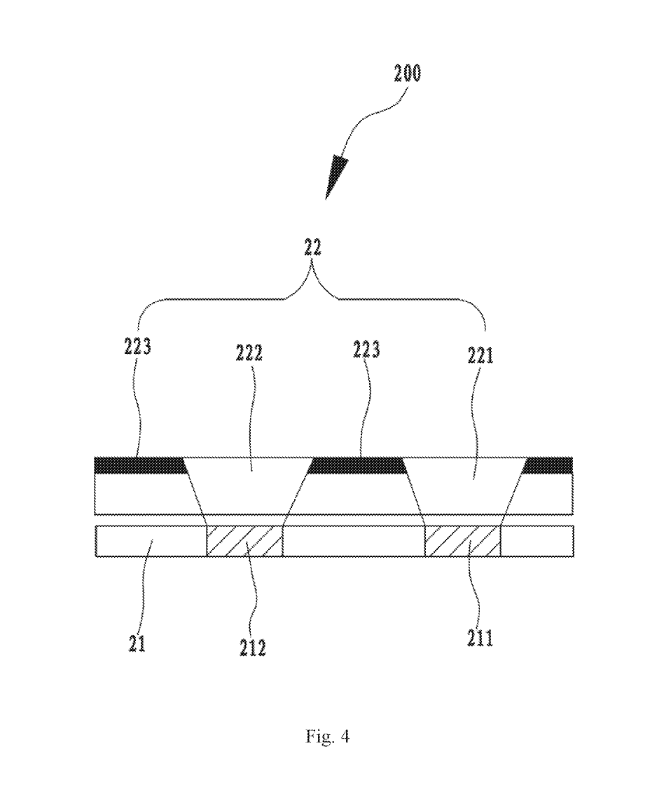

FIG. 4 is a schematic structural view of a laser ranging device 200 according to a second implementation of the present disclosure. The laser ranging device 200 includes a laser ranging sensor 21 and a cover plate 22. A light emitter 211 and a light receiver 212 are provided separately in the laser ranging sensor 21. The cover plate 22 is provided above the laser ranging sensor 21, and the cover plate 22 includes a first light-transmitting portion 221, a second light-transmitting portion 222, and a light-blocking layer 223. The first light-transmitting portion 221 and the second light-transmitting portion 222 are provided correspondingly to the light emitter 211 and the light receiver 212, respectively. The light emitter 211 emits a light beam to the detected object through the first light-transmitting portion 221, and the light beam is reflected to the light receiver 212 through the second light-transmitting portion 222 by the detected object and is received by the light receiver 212. The light-blocking layer 223 is provided between the first light-transmitting portion 221 and the second light-transmitting portion 222.

The laser ranging device 200 according to the second implementation of the present disclosure differs from the laser ranging device 100 according to the first implementation in that the light-blocking layer 223 is provided on the surface of cover plate 22, and the first light-transmitting portion 221 and the second light-transmitting portion 222 are exposed.

Typically, the cover plate 22 is formed of transparent material, and the light-blocking layer 223 is provided on the surface of the cover plate 22, thereby preventing the light emitter 211 from emitting the light beam through a position rather than the first light-transmitting portion 221. Typically, the light-blocking layer 223 may be a metal layer attached to the surface of the cover plate 22, a graphite sheet attached to the surface of the cover plate 22, or a black ink layer printed on the surface of the cover plate 22, so as to ensure the light-blocking effect. In addition, when the light-blocking layer 223 is a metal layer, a surface-oxidized aluminum sheet, iron sheet, steel sheet, or the like may be selected. It should be understood that, in other implementations, the light-blocking layer 223 may also be a light-blocking cloth attached to the surface of the cover plate 22.

When the light-blocking layer 223 is provided on the surface of the cover plate 22, positions corresponding to the first light-transmitting portion 221 and the second light 222 may be configured to be perforated, so as to expose the first light-transmitting portion 221 and a second light-transmitting portion 222.

In the laser ranging device 200 according to the second implementation of the present disclosure, the light-blocking layer 223 is provided on the surface of the cover plate 22, and in the positions corresponding to the first light-transmitting portion 221 and the second light-transmitting portion 222, the first light-transmitting portion 221 and the second light-transmitting portion 222 are exposed, thereby ensuring that the light emitter 211 can emit the light through the light-transmitting portion 221 and ensuring that the light emitted by the light emitter 211 to the outside of the first light-transmitting portion 221 is blocked by the light-blocking layer 223. In addition, since the light-blocking layer 223 is provided on the surface of the cover plate 22, the light-blocking layer 223 may be provided on the surface of the cover plate 22 by means of sticking or printing, so as to facilitate machining the cover plate 22 and facilitate the formation of the light-blocking layer 223.

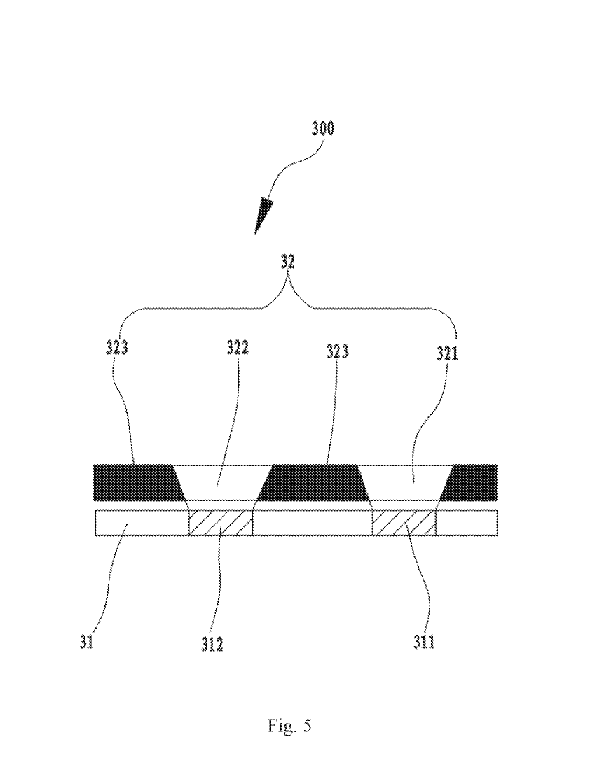

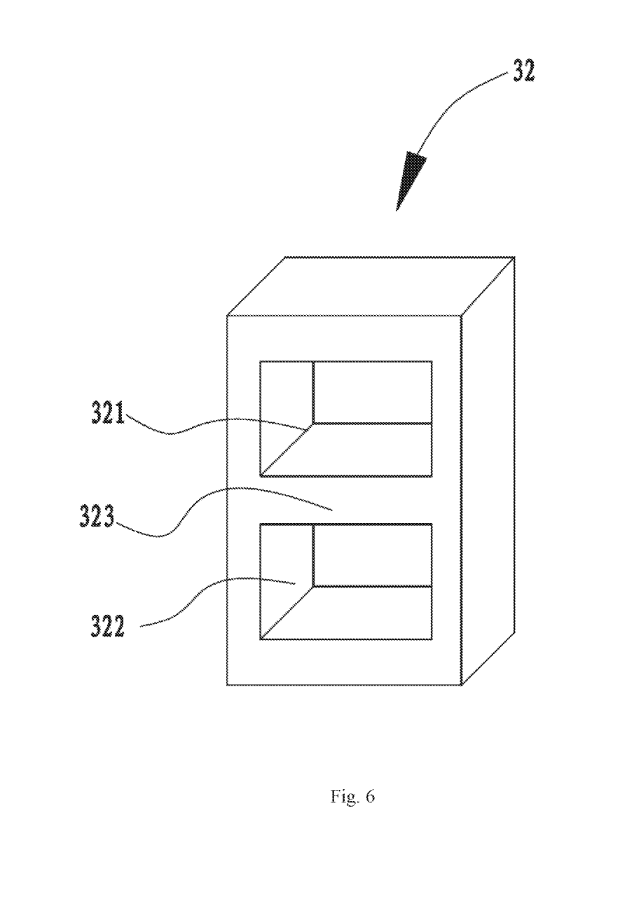

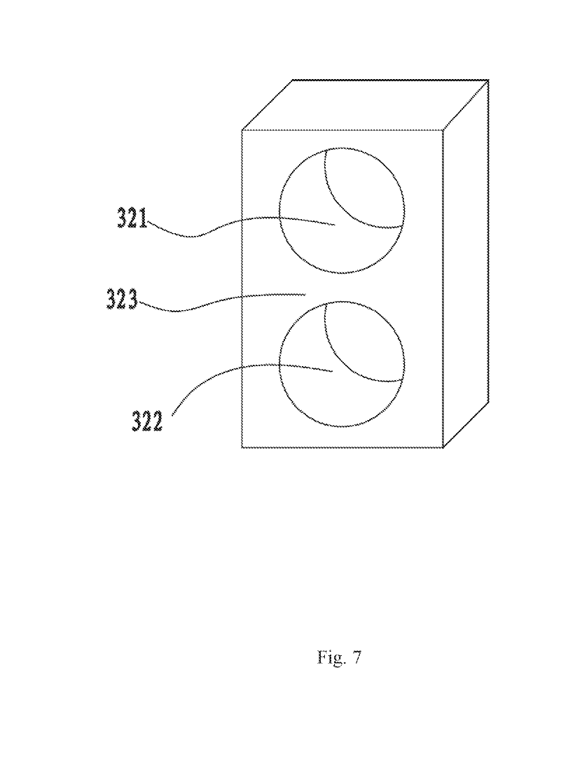

FIGS. 5 to 7 are schematic structural views of a laser ranging device 300 according to a third implementation of the present disclosure. The laser ranging device 300 includes a laser ranging sensor 31 and a cover plate 32.

The laser ranging device 300 according to the third implementation of the present disclosure differs from the laser ranging device 200 according to the second implementation in that the cover plate 32 is formed of lightproof material and the first light-transmitting portion 321 and the second light-transmitting portion 322 of the cover plate 32 are both through holes formed in the cover plate 32.

In this implementation, the material of the cover plate 32 may be metal or graphite. That is to say, the cover plate 32 may be an oxidized aluminum plate, an oxidized iron plate, a graphite block, or the like. Other positions except the first light-transmitting portion 321 and the second light-transmitting portion 322 in the cover plate 32 are formed of the lightproof material, i.e., the light-blocking layer 323, thereby further preventing the light emitter 311 of the laser ranging sensor 31 from emitting the light beam to a position rather than the first light-transmitting portion 321, and in turn preventing the light beam from being reflected to the light receiver 312 of the laser ranging sensor 31. Typically, when the cover plate 32 is machined, a metal piece having two light-transmitting holes may be mounted in a mold, and after transparent material is injected, the light-transmitting holes are filled with the transparent material.

Furthermore, the first light-transmitting portion 321 and the second light-transmitting portion 322 may be square holes or circular holes, so as to facilitate the light emission of the light emitter 311 and the light receipt of the light receiver 312. In addition, the cross-section of the first light-transmitting portion 321 and the second light-transmitting portion 322 may be T-shaped or tapered, so as to facilitate the light emission of the light emitter 311.

For further improvements, openings at both ends of the first light-transmitting portion 321 and openings at both ends of the second light-transmitting portion 322 are covered by light-transnlitting baffles (not illustrated), respectively. By means of providing the light-transmitting baffles covering the openings at both ends of the first light-transmitting portion 321 and the openings at both ends of the second light-transmitting portion 322, dust and impurities can be prevented from entering the inside of the first light-transmitting portion 321 and the second light-transmitting portion 322, thereby ensuring the cleanness of the cover plate 32 and preventing the dust and impurities from interfering with the reflection of the light.

In the laser ranging device 300 according to the third implementation of the present disclosure, the cover plate 32 is formed of the lightproof material, and the first light-transmitting portion 321 and the second light-transmitting portion 322 of the cover plate 32 are both through holes formed in the cover plate 32, thereby enabling the positions corresponding to the light emitter 311 and the light receiver 312 of the laser ranging sensor 31 to transmit the light and the other positions of the cover plate 32 to block the light, thus further preventing the light beam emitted by the light emitter 311 to the other positions except the first light-transmitting portion 321 from being reflected to and received by the light receiver 312. to cause interference for the ranging, and ensuring the accuracy of the ranging result.

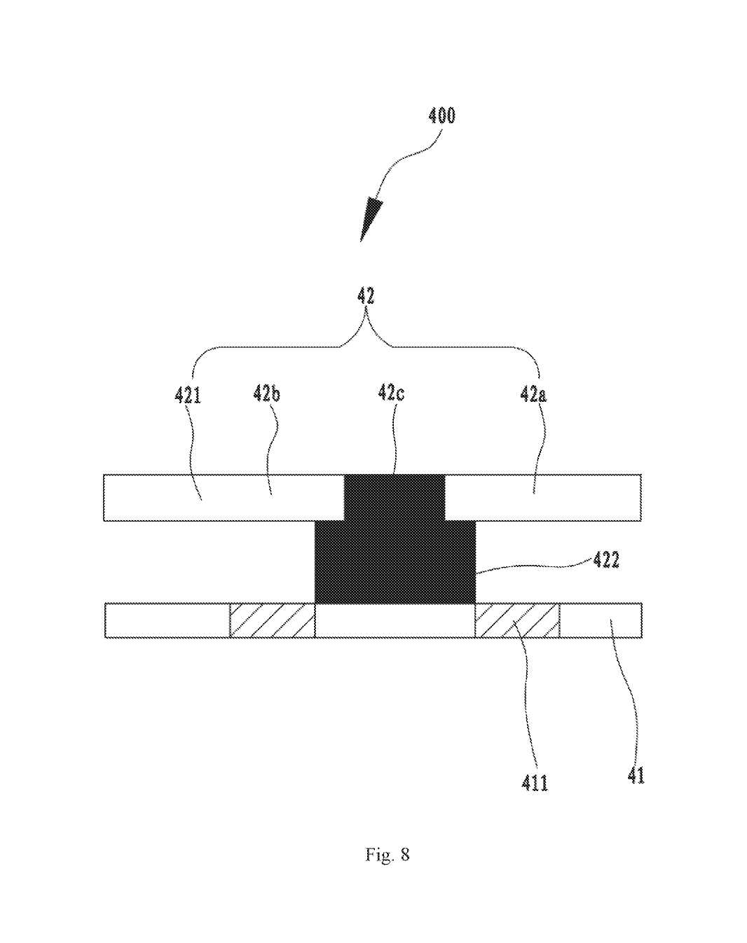

FIG. 8 is a schematic view of a laser ranging device 400 according to a fourth implementation of the present disclosure. The laser ranging device 400 includes a laser ranging sensor 41 and a cover plate 42.

The laser ranging device 400 according to the fourth implementation of the present disclosure differs from the laser ranging device 100 according to the first implementation in that the cover plate 42 is an integrally molded T-shaped structure. The cover plate 42 includes a slat 421 and a baffle 422. The first light-transmitting portion 42a and the second light-transmitting portion 42b of the cover plate 42 are both provided on the slat 421. The baffle 422 is located between the first light-transmitting portion 42a and the second light-transmitting portion 42b, and the baffle 422 is perpendicularly connected to the light-blocking layer 42c of the cover plate 42.

In this implementation, the baffle 422 is formed of lightproof material. The baffle 422 can further block the light emitted by the light emitter 411 of the laser ranging sensor 41 to a surface of the cover plate 42 toward the light emitter 411, thereby further preventing optical crosstalk.

It should be understood that, in other implementations, the cover plate 42 may also be a strip-shaped structure. The baffle 422 is provided on the surface of the cover plate 42 toward the laser ranging sensor 41, and the baffle 422 is located between the first light-transmitting portion 42a and the second light-transmitting portion 42b. In this way, the baffle 422 and the cover plate 42 are separately formed, so as to facilitate the molding of the cover plate 42.

In the laser ranging device 400 according to the fourth implementation of the present invention, the baffle 422 is provided between the first light-transmitting portion 42a and the second light-transmitting portion 42b, thereby preventing the light emitter from emitting the light to a position rather than the first light-transmitting portion 42a and preventing the light from being reflected to the light receiver, further preventing crosstalk due to the light ray, and ensuring the accuracy of the measurement result of the laser ranging device 100.

In the laser beam ranging device according to the present disclosure, the first light-transmitting portion and the second light-transmitting portion are provided in the positions in the cover plate corresponding to the light receiver and the light emitter of the laser ranging sensor, respectively, so as to facilitate light transmission and light receipt, and the light-blocking layer capable of blocking the light beam emitted by the light emitter to a position rather than the first light-transmitting portion is provided between the first light-transmitting portion and the second light-transmitting portion, thereby preventing the light beam from being reflected to the light receiver to cause crosstalk for emission and receipt of the infrared light, and ensuring the accuracy of the result of the laser ranging sensor measuring the target distance.

In the description of the specification, description of reference terms, such as “one implementation”, “some implementations”, “example”, “embodiment”, “some examples”, “first implementation”, or the like is intended to mean that specific features, structures, materials, or characteristics described in conjunction of the implementation or example are included in at least one implementation or example of the present disclosure. In this specification, the exemplary description of the above-mentioned terms does not necessarily refer to the same implementations or examples. Moreover, the described specific features, structures, materials, or characteristics may be combined appropriately in any one or more implementations or examples.

The foregoing is the typical implementations of the present disclosure. It should be noted that, for persons skilled in the art, several improvements and modifications can be made without departing from the principles of the present disclosure, and these improvements and modifications also fall within the protection scope of the present disclosure.

1. A laser ranging device, wherein the laser ranging device comprises a laser ranging sensor and a cover plate, a light emitter and a light receiver are provided separately in the laser ranging sensor, the cover plate is provided above the laser ranging sensor, the cover plate includes a first light-transmitting portion, a second light-transmitting portion, and a light-blocking layer, the first light-transmitting portion and the second light-transmitting portion are provided correspondingly to the light emitter and the light receiver, respectively, the light emitter emits a light beam to a detected object through the first light-transmitting portion, the light beam is reflected to the light receiver through the second light-transmitting portion by the detected object and is received by the light receiver, and the light-blocking layer is provided between the first light-transmitting portion and the second light-transmitting portion.

2. The laser ranging device of claim 1, wherein the light-blocking layer is embedded in the cover plate.

3. The laser ranging device of claim 1, wherein the cover plate is formed of lightproof material, and the first light-transmitting portion and the second light-transmitting portion are both through holes formed in the cover plate.

4. The laser ranging device of claim 3, wherein openings at both ends of the first light-transmitting portion and openings at both ends of the second light-transmitting portion are covered by light-transmitting baffles, respectively.

5. The laser ranging device of claim 1, wherein the cover plate is formed of transparent material, the light-blocking layer is provided on the surface of cover plate, and the first light-transmitting portion and the second light-transmitting portion are exposed.

6. The laser ranging device of claim 5, wherein the light-blocking layer is a metal layer attached to the surface of the cover plate, a graphite sheet attached to the surface of the cover plate, or a black ink layer printed on the surface of the cover plate.

7. The laser ranging device of claim 1, wherein the cover plate is an integrally molded T-shaped structure including a slat and a baffle, the first light-transmitting portion and the second light-transmitting portion are both provided on the slat, the baffle is located between the first light-transmitting portion and the second light-transmitting portion, and the baffle is perpendicularly connected to the light-blocking layer.

8. The laser ranging device of claim 1, wherein the cover plate is a strip-shaped structure, the baffle is provided on a surface of the cover plate toward the laser ranging sensor, and the baffle is located between the first light-transmitting portion and the second light-transmitting portion.

9. An image-capturing apparatus, wherein the image-capturing apparatus comprises a camera assembly, a processor, and the laser ranging device of claim 1, the processor is electrically connected to the camera assembly, the laser ranging device is electrically connected to the processor, the laser ranging device sends a measurement result to the processor, and the processor feeds the measurement result back to the camera assembly such that the camera assembly receives the measurement result and performs focusing for capturing images.

10. A terminal, wherein the terminal comprises a housing and the image-capturing apparatus of claim 9 which is provided in the housing.

11. The image-capturing apparatus of claim 9, wherein the light-blocking layer is embedded in the cover plate.

12. The image-capturing apparatus of claim 9, wherein the cover plate is formed of lightproof material, and the first light-transmitting portion and the second light-transmitting portion are both through holes formed in the cover plate.

13. The image-capturing apparatus of claim 12, wherein openings at both ends of the first light-transmitting portion and openings at both ends of the second light-transmitting portion are covered by light-transmitting baffles, respectively.

14. The image-capturing apparatus of claim 9, wherein the cover plate is formed of transparent material, the light-blocking layer is provided on the surface of cover plate, and the first light-transmitting portion and the second light-transmitting portion are exposed.

15. The image-capturing apparatus of claim 14, wherein the light-blocking layer is a metal layer attached to the surface of the cover plate, a graphite sheet attached to the surface of the cover plate, or a black ink layer printed on the surface of the cover plate.

16. The image-capturing apparatus of claim 9, wherein the cover plate is an integrally molded T-shaped structure including a slat and a baffle, the first light-transmitting portion and the second light-transmitting portion are both provided on the slat, the baffle is located between the first light-transmitting portion and the second light-transmitting portion, and the baffle is perpendicularly connected to the light-blocking layer.

17. The image-capturing apparatus of claim 9, wherein the cover plate is a strip-shaped structure, the baffle is provided on a surface of the cover plate toward the laser ranging sensor, and the baffle is located between the first light-transmitting portion and the second light-transmitting portion.

18. The terminal of claim 10, wherein the light-blocking layer is embedded in the cover plate.

19. The terminal of claim 10, wherein the cover plate is formed of lightproof material, and the first light-transmitting portion and the second light-transmitting portion are both through holes formed in the cover plate.

20. The terminal of claim 19, wherein openings at both ends of the first light-transmitting portion and openings at both ends of the second light-transmitting portion are covered by light-transmitting baffles, respectively.
